(19) United States
(12) Patent Application Publication
(10) Pub. No.: US 2021/0255147 A1
(43) Pub. Date: Aug. 19, 2021

(54) SENSOR ARRANGEMENT, USE OF THE SENSOR ARRANGEMENT AND METHOD FOR DETECTING STRUCTURE-BORNE NOISE

(71) Applicant: iNDTact GmbH, Würzburg (DE)

(72) Inventor: Raino PETRICEVIC, Würzburg (DE)

(21) Appl. No.: 17/253,040

(22) PCT Filed: Jun. 24, 2019
(86) PCT No.: PCT/EP2019/066670

§ 371 Date: Dec. 16, 2020

(30) Foreign Application Priority Data
Jun. 22, 2018 (DE) 10 2018 115 098.9

(51) Int. Cl. G01N 29/12; G01H 5/00; G06K 9/62; G06N 3/08

(52) U.S. Cl. CPC G01N 29/12; G06N 3/08; G06K 9/6257; G01H 5/00

(57) ABSTRACT

Method for detecting structure-borne sound, comprising the following steps: attaching a structure-borne sound sensor (3) to a fastening position on the body or on an article of clothing of a user, wherein the structure-borne sound sensor (3) is connected to a controller designed to evaluate the sensor signals of the structure-borne sound sensor (3), detection of structure-borne sound generated by a manual action of the user and transmitted via the skeleton, i.e. via bones and/or tendons, in the user's body to the fastening position by means of the structure-borne sound sensor (3), determining by the controller using the evaluated sensor signals, whether or not the structure-borne noise generated by the manual activity sufficiently matches a stored structure-borne noise profile, whereby the structure-borne sound sensor (3) detects the structure-borne sound generated by the manual activity of the user and transmitted essentially via the skeleton, i.e. via bones and/or tendons, in the user's body to the fastening position, wherein training data is generated virtually by artificial variation of acquired signals.

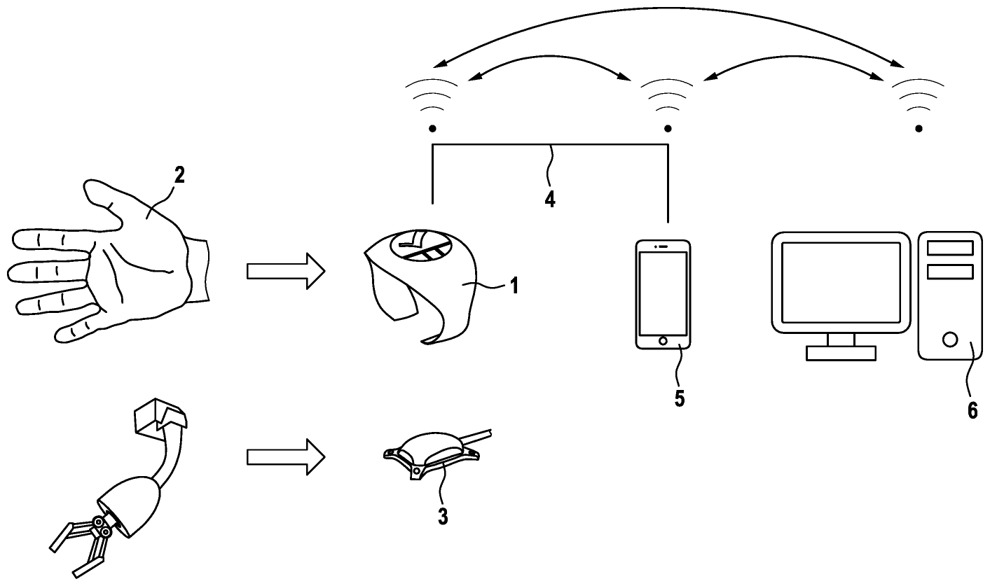

The invention refers to a sensor arrangement according to the preamble of claim 1.

During the assembly of components, machines and systems, many activities are performed manually. Examples are the positioning and fastening of individual parts and the production of plug connections. In practice, it has been found that the manual production of plug connections is particularly prone to errors. It is therefore necessary to check every single manually produced plug connection, which results in a comparatively high effort in the context of quality assurance.

Therefore, the object of the invention is to provide a sensor arrangement which, in the case of manual assembly, enables the monitoring of a manual activity.

To obtain this object, a sensor arrangement with the features of claim 1 is provided.

The sensor arrangement in accordance with the invention comprises a structure-borne sound sensor which can be detachably attached to a mounting position on the body of a user and is capable of detecting structure-borne sound generated by the user through a manual action in the form of sensor signals. The sensor arrangement comprises a controller which is connected to the structure-borne sound sensor and is designed to evaluate the sensor signals of the structure-borne sound sensor, the controller being able to determine, on the basis of the evaluated sensor signals, whether or not the structure-borne sound generated by the manual action sufficiently corresponds to a stored structure-borne sound profile. The sensor arrangement in accordance with the invention is characterized in that the structure-borne sound sensor is suitable for detecting the structure-borne sound generated by the manual activity of the user and transmitted in the user's body to the fastening position essentially via the skeleton, i.e. via bones and/or tendons.

The term “structure-borne sound sensor” is to be understood broadly. It can for example be a piezo sensor. The structure-borne sound sensor can be combined with a gyro sensor and/or a position sensor.

The controller serves as an evaluation device, which is designed for pre-filtering and/or evaluation of the sensor signals of the structure-borne sound sensor.

The invention is based on the consideration that during the performance of a manual activity, in particular during an assembly activity, structure-borne noise is generated which is transmitted to the hand and fingers of the user. This structure-borne sound is transmitted via the skeleton, i.e. via bones and/or tendons, of the user's body. By recording the structure-borne sound by means of the structure-borne sound sensor and subsequent evaluation, it can be assessed whether or not the structure-borne sound corresponds to a known and/or stored structure-borne sound profile. Certain standard activities within the scope of an assembly, e.g. the production of a plug connection, are characterized by the fact that a characteristic structure-borne sound profile is generated. By comparing the known structure-borne noise profile with currently recorded sensor signals, it is thus possible to assess whether the manual activity performed was carried out correctly or whether it is faulty.

The advantage of the sensor arrangement according to the invention is that the structure-borne sound sensor does not necessarily have to be attached to a finger of the user's hand. Since the structure-borne sound is transmitted via the skeleton, i.e. via bones and/or tendons, in the user's body, it is sufficient to detachably attach the sensor assembly to any suitable mounting position on the user's body. For example, the sensor array can be attached to the upper arm with a strap. Alternatively, it is also possible to attach the sensor array to the user's belt, for example. The sensor array can also be integrated into a piece of clothing.

Accordingly, the sensor array can be attached to the user's body in almost any position. Since the resulting structure-borne noise becomes weaker with increasing distance from the place of sound generation, i.e. with increasing distance from the user's hand, mounting positions are preferred where a sufficiently safe detection of the structure-borne noise is possible.

Alternatively, the sensor assembly can be attached to a tool or a mounting bracket. Structure-borne sound is then transmitted from the tool or mounting bracket via the user's skeleton to the structure-borne sound sensor.

In addition, the invention relates to the use of the sensor arrangement according to the invention for detecting the body sound generated by the manual activity of the user and transmitted essentially via the skeleton, i.e. via bones and/or tendons, in the body of the user to the fastening position. By means of the sensor arrangement in accordance with the invention, structure-borne sound generated during manual activity can thus be detected and evaluated.

In addition, the invention relates to a method for detecting structure-borne sound, with the following steps: attaching a structure-borne sound sensor to an attachment position on the body or on an item of clothing of a user, the structure-borne sound sensor being connected to a controller designed to evaluate the sensor signals of the structure-borne sound sensor, detecting structure-borne sound by means of the structure-borne sound sensor generated by a manual action of the user, which is transmitted via the skeleton, i.e. via bones and/or tendons, in the body of the user to the fastening position, determining by means of the evaluated sensor signals by the controller whether or not the structure-borne sound generated by the manual action sufficiently corresponds to a stored structure-borne sound profile, the structure-borne sound sensor detecting the structure-borne sound generated by the manual action of the user and transmitted substantially via the skeleton, i.e. via bones and/or tendons, in the body of the user to the fastening position.

The invention is explained below by means of embodiments with reference to the drawing. The drawing is a schematic representation and shows embodiments of the sensor arrangement according to the invention.

The sensor arrangement 1 shown in the single figure is designed as a so-called “wearable”, in this embodiment in the form of a bracelet or bangle. However, this design is only to be understood as an example.

During a manual activity, for example when assembling plug connections, structure-borne sound is generated, which is transmitted to the hand 2 of a user. From there, structure-borne sound is transmitted via the skeleton, i.e. via bones and/or tendons, of the user's body and/or skin to the mounting position of the sensor array 1. The sensor array may be attached to a user's forearm, upper arm, belt, or integrated into a user's clothing.

The sensor arrangement 1 includes a schematic representation of the structure-borne sound sensor 3 which is characterized by a high sensitivity and is able to detect structure-borne sound of low intensity.

The sensor arrangement 1 is equipped with a communication device that enables wireless transmission via a radio protocol. The transmission can take place for example via WLAN, via Bluetooth or another radio transmission method. By means of the communication device an exchange of information with another mobile or stationary device can take place.

Alternatively or additionally, the sensor array 1 can also be connected via a cable 4 to a mobile device 5 or a stationary device 6 like a PC. The mobile device 5 can be a single-board computer, an embedded PC or a conventional mobile device such as a smartphone or tablet computer. The stationary device can be a PC, a remote computer located in a data center, or a computer connected via the internet. Mobile Device 5 also includes a communication device for wireless communication. The sensor array 1 can also be connected to the stationary computer 6 via a wireless communication link, for example, a cellular network. The sensor array 1, which is in accordance with the invention, is also suitable for detecting structure-borne noise generated during the operation of a machine or device. The structure-borne sound is transmitted via the mechanical structure, for example a machine housing. Thus, a machine, for example a manipulator or a robot, can also be monitored by means of the sensor arrangement according to the invention. By detecting structure-borne sound, it can be determined, for example, whether a robot has gripped a certain tool, since different tools generate different structure-borne sound profiles.

Besides, different optional variants and further developments of the sensor arrangement with its individual components are possible:

According to one variant, the sensor arrangement includes the sensor (structure-borne sound sensor), an amplifier, a battery and a cable connection.

According to another variant, the sensor arrangement includes the structure-borne sound sensor, the amplifier and a cable connection.

According to another variant, the sensor arrangement includes the structure-borne sound sensor, the amplifier, an A/D converter, a battery and a cable connection.

According to another variant, the sensor arrangement includes the sensor, the amplifier, the A/D converter and a cable connection.

According to another variant, the sensor arrangement includes the structure-borne sound sensor, the amplifier, the A/D converter, the battery and a radio module that serves as a communication device.

According to another variant, the sensor arrangement includes the sensor, the amplifier, the A/D converter, the cable connection or a cable and the radio module.

According to another variant, the sensor arrangement includes the sensor, the amplifier, the A/D converter, an RFID transponder for near field communication (NFC), the battery and the radio module.

According to another variant, the sensor arrangement includes the sensor, the amplifier, the A/D converter, the RFID transponder and a cable.

According to another variant, the sensor arrangement comprises the sensor, the amplifier, the A/D converter, the RFID transponder for near-field communication, a controller, a battery and the radio module.

According to another variant, the sensor arrangement includes the sensor, the amplifier, the A/D converter, the RFID transponder to near field communication, the controller, and a cable.

The sensor can consist of a structure-borne sound sensor and/or a gyro sensor (acceleration sensor) and/or a position sensor.

With the sensor arrangement according to the invention, the signal is acquired by means of the sensor, in particular by means of the structure-borne sound sensor. Optionally, signal processing can also be performed directly by the sensor arrangement. Alternatively, analogue and/or digital sensor signals can be transmitted wirelessly to the mobile device 5 or a stationary computer 6 via the cable 4 shown in the figure or by means of the communication device. Via the cable 4, the sensor array 1 can also be supplied with electrical energy. After the evaluation of the sensor signals, e.g. by the mobile device 5 or by the stationary computer 6, a feedback is sent back to the sensor array 1, so that a signal can be output there for the user. The signal can be an optical and/or acoustic and/or haptic signal. The output feedback signal informs the user that an installation process has been performed correctly or incorrectly. For example, a certain acoustic signal or a visual signal can be output if a connector is found to be incorrectly installed, although these signals differ from those for correct installation. It is also possible that a signal is only issued in the event of a fault, i.e. if an incorrect plug connection or similar is detected.

All described variants and combinations of features can also be combined with each other or individual characteristics can be omitted.

### REFERENCE NUMBERS

1 sensor arrangement

2 hand

3 structure-borne sound sensor

4 cable

5 mobile device

6 device

1-7. (canceled)

8. A method for detecting structure-borne sound, comprising the following steps:
attaching a structure-borne sound sensor to a fastening position on the body or on an article of clothing of a user, wherein the structure-borne sound-sensor is connected to a controller designed to evaluate the sensor signals of the structure-borne sound sensor,
detection of structure-borne sound generated by a manual action of the user and transmitted via the skeleton, i.e. via bones and/or tendons, in the user's body to the fastening position by means of the structure-borne sound sensor,
determining by the controller using the evaluated sensor signals,
whether or not the structure-borne noise generated by the manual activity sufficiently matches a stored structure-borne noise profile,
wherein the structure-borne sound sensor detects the structure-borne sound generated by the manual activity of the user and transmitted essentially via the skeleton, bones and/or tendons, in the user's body to the fastening position, and wherein training data is generated virtually by artificial variation of acquired signals.

9-11. (canceled)

12. The method according to claim 8, wherein the training data are generated by variable superposition with determined noise and/or by variable superposition with transfer functions.

13. The method according to claim 8, whereby artificial intelligence is trained by means of the training data.

14. The method according to claim 8, whereby artificial intelligence is trained by artificial neural networks.

15. The method according to claim 8, whereby one or more signals are recorded as time signal and/or as frequency spectrum.

16. The method according to claim 15, whereby one or more signals are recorded during the manufacture of a plug connection.

17. The method according to claim 12, whereby artificial intelligence is trained by means of the training data.

18. The method according to claim 12, whereby artificial intelligence is trained by artificial neural networks.
